(19) United States
(12) Patent Application Publication
(10) Pub. No.: US 2026/0210523 A1
(43) Pub. Date: Jul. 23, 2026

(54) Lamp

(71) Applicants: ETI SOLID STATE LIGHTING INC, Wheeling, IL (US); CRAWFORD GLOBAL LIMITED, Hong Kong (CN)

(72) Inventors: Donglei WANG, Zhuhai (CN); Jibin Cheng, Zhuhai (CN)

(21) Appl. No.: 19/435,666

(22) Filed: Dec. 29, 2025

Related U.S. Application Data
(63) Continuation of application No. PCT/CN2023/105189, filed on Jun. 30, 2023.

(51) Int. Cl. F21V 3/00; F21V 8/00; F21Y 103/10; F21Y 103/33

(52) U.S. Cl. CPC F21V 3/00; G02B 6/0068; F21Y 2103/10; F21Y 2103/33

(57) ABSTRACT

Disclosed is a lamp. The lamp includes a lamp body, a first light emitting assembly and a second light emitting assembly. The first light emitting assembly and the second light emitting assembly are independently arranged on the lamp body. The first light emitting assembly has a first light emitting region, the first light emitting assembly at least includes an image layer arranged in the first light emitting region, and light from the first light emitting region passes through the image layer before scene light is emitted. The second light emitting assembly has a second light emitting region configured to emit illumination light. The lamp provided by the disclosure may solve the problem that a lamp in the related art offers poor use experience due to a single light color.

### CROSS-REFERENCE TO RELATED APPLICATION

The present disclosure claims the priority to the PCT International Application No. PCT/CN2023/105189 filed on June 30, 2023, which is incorporated herein by reference in its entirety.

### TECHNICAL FIELD

The disclosure relates to the technical field related to illumination devices, and particularly relates to a lamp.

### BACKGROUND OF THE INVENTION

For satisfying daily illumination demand, lamps have been employed in lives and work. Existing lamps on the market are used for illumination with only one light source in most cases.

Increasing demand for life quality is fueling demand for light. Lamps with a light intensity adjustable have come into being in existing designs. They may suit different people and different illumination demand. However, no matter how the lamps in the existing design are adjusted, they are only used for illumination, with a relatively single light color. People are likely to feel fatigued in an environment with a single light source after a long time.

As a result, an existing lamp offers poor use experience due to a single light color.

### SUMMARY OF THE INVENTION

Some embodiments of the disclosure provide a lamp, so as to solve the problem that a lamp in the related art offers poor use experience due to a single light color.

In order to achieve the above objective, an embodiment according to the disclosure provides a lamp. The lamp includes a lamp body; a first light emitting assembly, where the first light emitting assembly has a first light emitting region, the first light emitting assembly at least includes an image layer arranged in the first light emitting region, and light from the first light emitting region passes through the image layer before scene light is emitted; and a second light emitting assembly, where the first light emitting assembly and the second light emitting assembly are independently arranged on the lamp body, and the second light emitting assembly has a second light emitting region configured to emit illumination light.

In an embodiment mode, the first light emitting region and the second light emitting region emit light with main light emitting directions facing the same side of the lamp body; or main light emitting directions of the first light emitting region and the second light emitting region are formed with an angle therebetween; or the first light emitting region is of an annular structure, and the second light emitting region is located in the first light emitting region; or the second light emitting region is of an annular structure, and the first light emitting region is located in the second light emitting region; or the first light emitting region and the second light emitting region are alternately arranged in a length direction of the lamp body.

In an embodiment mode, a first light emitting surface of the first light emitting region and a second light emitting surface of the second light emitting region are staggered in a height direction of the lamp body.

In an embodiment mode, the first light emitting surface is located above the second light emitting surface.

In an embodiment mode, in a height direction of the lamp body, the first light emitting region emits light with a main light emitting direction facing away from the lamp body; and/or in a direction perpendicular to a height of the lamp body, the first light emitting region emits light towards a lateral of the lamp body; and/or in a height direction of the lamp body, the first light emitting region emits light towards the lamp body.

In an embodiment mode, in a height direction of the lamp body, the second light emitting region emits light in a direction facing away from the lamp body; and/or in a direction perpendicular to a height of the lamp body, the second light emitting region emits light towards a lateral of the lamp body; and/or in a height direction of the lamp body, the second light emitting region emits light towards the lamp body.

In an embodiment mode, the lamp body is in a shape of a polygon, a circle or an ellipse, or a combination of at least two of the polygon, the circle and the ellipse.

In an embodiment mode, the first light emitting assembly includes a first light source; a first light output assembly, where the first light output assembly is arranged on the lamp body and spaced from an inner bottom surface of the lamp body, the first light source is arranged at an outer lateral of the first light output assembly, and/or the first light source is arranged between the first light output assembly and an inner bottom surface of the lamp body; and the image layer, where the image layer is arranged on the first light output assembly and/or the lamp body.

In an embodiment mode, when the first light source is arranged at the outer lateral of the first light output assembly, the first light output assembly at least includes a transparent plate, the image layer is arranged between the inner bottom surface of the lamp body and the transparent plate, and one side of the transparent plate away from the image layer is formed with a first light emitting surface; and when the first light source is arranged between the first light output assembly and the inner bottom surface of the lamp body, the first light output assembly at least includes a transparent plate, the image layer is arranged on one side of the transparent plate facing the first light source, and one side of the transparent plate away from the image layer is formed with a first light emitting surface.

In an embodiment mode, the first light output assembly further includes a light guide plate arranged between the transparent plate and the inner bottom surface of the lamp body, the image layer is a light transmitting film having an image, and the light transmitting film is attached to the first light output assembly; or the image layer is an ink layer printed on the first light output assembly; or the image layer is an image plate having a pattern.

In an embodiment mode, the first light emitting assembly further includes a spacer layer, where the spacer layer is directly formed between the transparent plate and the image layer; or a spacer plate, where the spacer plate is arranged between the transparent plate and the image layer, and the spacer plate abuts against a peripheral region of the transparent plate and the image layer, such that a spacer layer is formed between a central area of the transparent plate and a central area of the image layer.

In an embodiment mode, the second light emitting assembly includes a second light source, where the second light source is arranged on the lamp body; and a second light output assembly, where the second light output assembly is arranged on the lamp body and spaced from an inner bottom surface of the lamp body, the second light source is arranged at an outer lateral of the second light output assembly, and/or the second light source is arranged between the second light output assembly and an inner bottom surface of the lamp body, and a side surface of the second light output assembly away from the lamp body is a second light emitting surface.

In an embodiment mode, the lamp body includes a back plate; and an enclosing plate, where the enclosing plate is mounted on a bottom surface of the back plate, the enclosing plate extends along a peripheral edge of the back plate so as to form a mounting cavity, and the first light emitting assembly and the second light emitting assembly are mounted in the mounting cavity.

In an embodiment mode, the lamp further includes a baffle, where the baffle is mounted in the mounting cavity, and the baffle separates the mounting cavity into the first light emitting region and the second light emitting region that are independent of each other.

In an embodiment mode, the baffle is of an annular structure, an inner peripheral surface of the baffle is formed with a light emitting region, and the light emitting region is the first light emitting region or the second light emitting region.

In an embodiment mode, in a length direction of the lamp body, the baffle is arranged between enclosing plates at two ends of the lamp body so as to separate the mounting cavity into two parallel regions independently configured in the length direction of the lamp body, one of the two parallel regions is the first light emitting region, and the other parallel region is the second light emitting region.

In an embodiment mode, the baffle is provided with an upper supporting part extending towards the first light emitting region and a lower supporting part extending towards the second light emitting region, the upper supporting part is located above the lower supporting part in the height direction of the lamp body, a top surface of the upper supporting part abuts against the first light emitting surface of the first light emitting assembly, and a top surface of the lower supporting part abuts against the second light emitting surface of the second light emitting assembly.

In an embodiment mode, the upper supporting part is arranged in parallel with the first light emitting surface; and/or the lower supporting part is arranged in parallel with the second light emitting surface.

In an embodiment mode, the first light emitting assembly at least includes the first light source, the baffle is provided with a mounting part, the mounting part is connected to the upper supporting part in a bent manner, a mounting groove is formed at a joint of the mounting part and the upper supporting part, and the first light source is mounted on an inner bottom surface of the back plate; and/or the first light source is attached to an end surface of the mounting part facing the first light emitting region and at least partially located in the mounting groove.

In an embodiment mode, the lamp further includes a controller, where the controller is in signal connection with the first light emitting assembly and/or the second light emitting assembly; and a control switch, where the control switch is in signal connection with the controller, the controller and the control switch are arranged on the lamp body or separated from the lamp body, and the control switch at least includes one of a color temperature adjustment switch, a scene light adjustment switch, and a power adjustment switch; and/or the lamp is one of a pendant lamp, a ceiling lamp, a table lamp, and a floor lamp.

According to the technical solution of the disclosure, the lamp includes the lamp body, the first light emitting assembly and the second light emitting assembly, the first light emitting assembly and the second light emitting assembly are independently arranged on the lamp body, the first light emitting assembly has the first light emitting region, the first light emitting assembly at least includes the image layer arranged in the first light emitting region, the light from the first light emitting region passes through the image layer before the scene light is emitted, and the second light emitting assembly has the second light emitting region configured to emit the illumination light.

It may be seen from the above description that the lamp body of the lamp of the disclosure is provided with the first light emitting assembly and the second light emitting assembly that emit light independently, where the first light emitting region emits the scene light to simulate environments, such as blue sky and white clouds, and the second light emitting region generates the illumination light for illumination. The lamp provided by the disclosure may not only achieve illumination, but also achieve a technical effect of creating a scene by means of the scene light. By means of the lamp, people may feel like in a comfortable, healthy and natural light environment, and may have a pleasant mood. According to the disclosure, the first light emitting assembly and the second light emitting assembly generate various light rays at the same time, such that a technical problem of single light rays in the related art is solved, and use experience is improved.

### BRIEF DESCRIPTION OF THE DRAWINGS

The accompanying drawings constituting a part of the disclosure serve to provide further understanding of the disclosure, and illustrative Embodiments of the disclosure and the description of the illustrative Embodiments serve to explain the disclosure and are not to be construed as unduly limiting the disclosure. In the drawings:

FIG. 1 shows an explosive view of a lamp according to Embodiment 1 of the disclosure;

FIG. 2 shows a section view of a lamp according to Embodiment 1 of the disclosure;

FIG. 3 shows an enlarged view of part D in FIG. 2;

FIG. 4 shows a schematic diagram of a stereoscopic structure of a lamp according to Embodiment 1 of the disclosure;

FIG. 5 shows another schematic diagram of a stereoscopic structure of a lamp according to Embodiment 1 of the disclosure;

FIG. 6 shows a section view of a lamp according to Embodiment 1 of the disclosure;

FIG. 7 shows a schematic structural diagram of a control switch according to the disclosure;

FIG. 8 shows an explosive view of a lamp according to Embodiment 2 of the disclosure;

FIG. 9 shows a section view of a lamp according to Embodiment 2 of the disclosure;

FIG. 10 shows an enlarged view of part C in FIG. 9;

FIG. 11 shows a section view of a lamp according to Embodiment 3 of the disclosure;

FIG. 12 shows a schematic diagram of a stereoscopic structure of a lamp according to Embodiment 3 of the disclosure;

FIG. 13 shows another schematic diagram of a stereoscopic structure of a lamp according to Embodiment 3 of the disclosure;

FIG. 14 shows a section view of a lamp according to Embodiment 3 of the disclosure;

FIG. 15 shows a schematic diagram of a stereoscopic structure of a lamp according to Embodiment 4 of the disclosure;

FIG. 16 shows another schematic diagram of a stereoscopic structure of a lamp according to Embodiment 4 of the disclosure;

FIG. 17 shows yet another schematic diagram of a stereoscopic structure of a lamp according to Embodiment 4 of the disclosure;

FIG. 18 shows yet another schematic diagram of a stereoscopic structure of a lamp according to Embodiment 4 of the disclosure;

FIG. 19 shows a section view of a lamp according to Embodiment 4 of the disclosure; and

FIG. 20 shows another schematic diagram of a stereoscopic structure of a lamp according to Embodiment 5 of the disclosure.

The above Figures involve the following reference numerals:

10, lamp body; 110, back plate; 120, enclosing plate; 20, first light emitting assembly; 201, first light emitting region; 210, first light source; 220, first light output assembly; 221, transparent plate; 222, image layer; 223, light guide plate; 224, reflective plate; 225, foam; 226, spacer plate; 2261, spacer layer; 30, second light emitting assembly; 301, second light emitting region; 310, second light source; 320, second light output assembly; 40, baffle; 410, upper supporting part; 420, lower supporting part; 430, mounting part; 440, mounting groove; 50, control switch; 510, color temperature adjustment switch; 520, scene light adjustment switch; 530, power adjustment switch.

### DETALIED DESCRIPTION OF THE INVENTION

It should be noted that embodiments in the disclosure and features in the embodiments may be combined with one another if there is no conflict. The disclosure will be described in details below with reference to the drawings and in combination with the embodiments.

It should be noted that all technical and scientific terms used in the disclosure have the same meanings as commonly understood by those of ordinary skill in the art to which the disclosure belongs unless otherwise indicated.

In the disclosure, unless otherwise stated, the orientation words such as “upper”, “lower”, “top” and “bottom” are generally used for directions shown in the drawings, or for components that are in a vertical direction, a perpendicular direction or a gravity direction; and similarly, for convenience of understanding and description, “inside” or “outside” refers to inside or outside relative to an outline of each component itself, but the above orientation words are not used to limit the disclosure.

### Embodiment 1

In order to solve the problem that a lamp in the related art offers poor use experience due to a single light color, the disclosure provides a lamp. The lamp is one of a pendant lamp, a ceiling lamp, a table lamp, and a floor lamp. The lamp may be used in the domestic or industrial field.

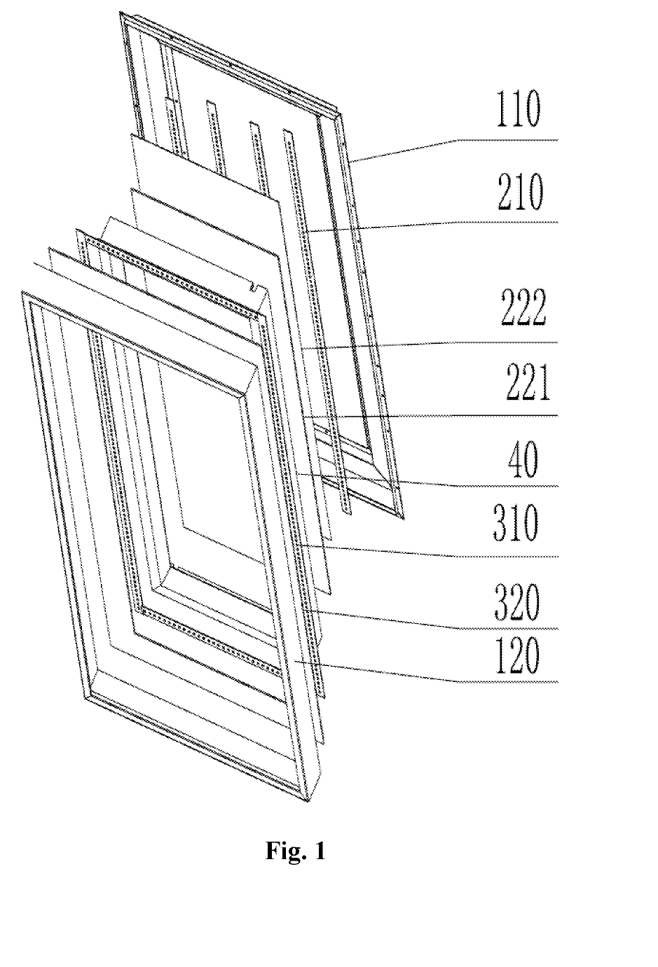

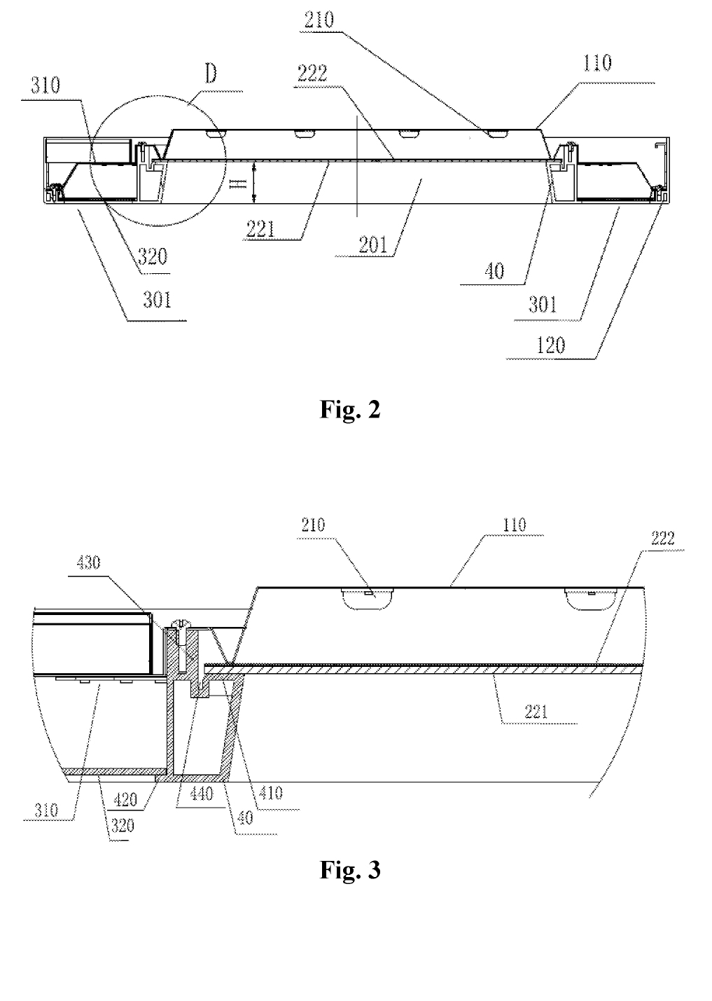

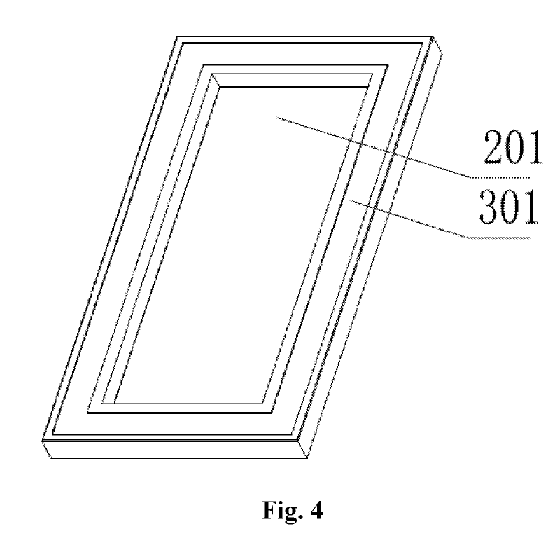

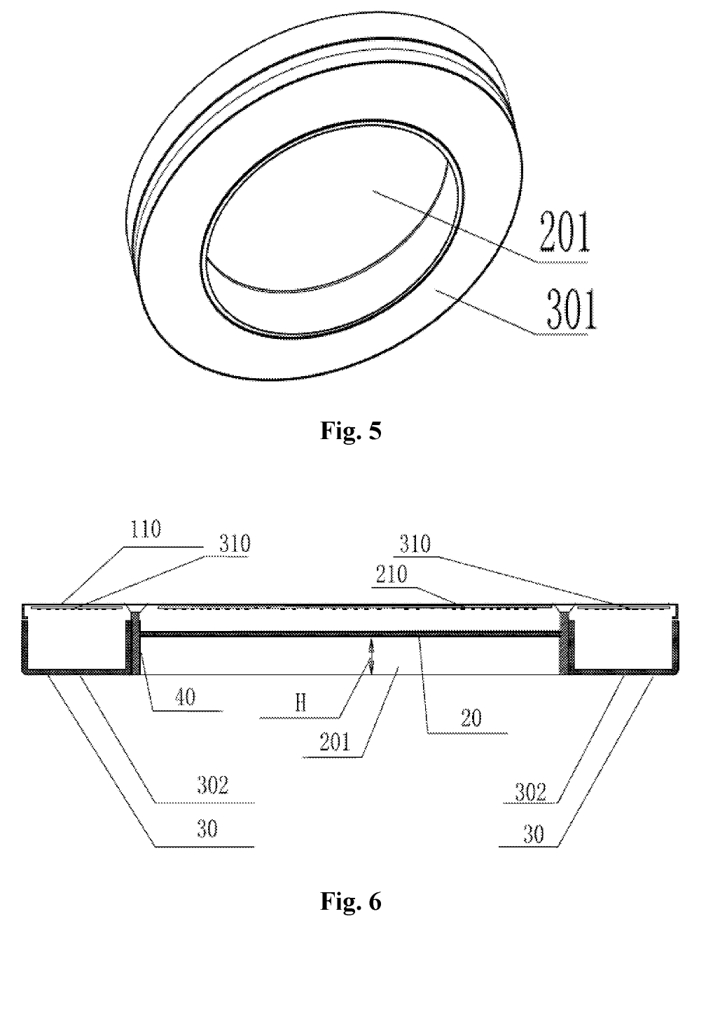

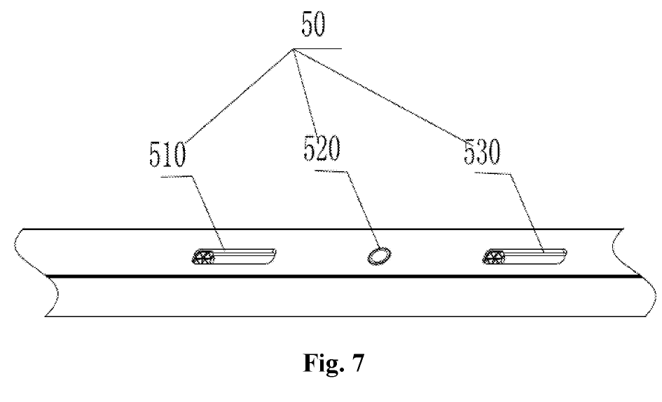

As shown in FIGS. 1-7, the lamp includes a lamp body 10, a first light emitting assembly 20, and a second light emitting assembly 30. The first light emitting assembly 20 has a first light emitting region 201. The first light emitting assembly 20 at least includes an image layer 222 arranged in the first light emitting region 201. Light from the first light emitting region 201 passes through the image layer 222 before scene light is emitted. The first light emitting assembly 20 and the second light emitting assembly 30 are independently arranged on the lamp body 10. The second light emitting assembly 30 has a second light emitting region 301 configured to emit illumination light.

Specifically, the lamp body 10 of the lamp of the disclosure is provided with the first light emitting assembly 20 and the second light emitting assembly 30 that emit light independently, where the first light emitting region 201 emits the scene light to simulate environments, such as blue sky and white clouds, and the second light emitting region 301 generates the illumination light for illumination. The lamp of the disclosure may not only achieve illumination, but also achieve a technical effect of creating a scene by means of the scene light. By means of the lamp, people may feel like in a comfortable, healthy and natural light environment, and may have a pleasant mood. According to the disclosure, the first light emitting assembly 20 and the second light emitting assembly 30 generate various light rays at the same time, such that a technical problem of single light rays in the related art is solved, and use experience is improved.

It should be noted that the scene light in the disclosure may be any natural or man-made scene image or a colorful combined pattern, which includes, but is not limited to, blue sky, white clouds, starry sky, a landscape painting, etc.

In an embodiment, the first light emitting assembly 20 and the second light emitting assembly 30 that are independently arranged may be turned on or off at the same time. Alternatively, one of the first light emitting assembly 20 and the second light emitting assembly 30 may be turned on while the other light emitting assembly may be turned off.

In the embodiment, a first light source 210 of the first light emitting region 201 and a second light source 310 of the second light emitting region 301 are both light emitting diode (LED) light sources having adjustable power. In order to enrich light colors of the scene light emitted from the first light emitting region 201, the LED light source of the first light source 210 uses white LED lamp beads having an adjustable color temperature, or red green blue (RGB) lamp beads having rich colors, such that different scene light may be emitted when different light rays pass through the image layer 222.

As shown in FIGS. 1-7, the first light emitting region 201 and the second light emitting region 301 emit light with main light emitting directions facing the same side of the lamp body 10.

The main light emitting directions of the first light emitting region 201 and the second light emitting region 301 face a light output port at a bottom of the lamp body 10, and the first light emitting region 201 may also emit part of the scene light towards a lateral or a top of the lamp body 10, such that the scene light emitted from the side and the top of the lamp body 10 may cooperate with scene light in a main light emitting direction so as to constitute a complete simulation scene. Similarly, the second light emitting region 301 may also emit part of the illumination light towards the lateral or the top of the lamp body 10, so as to expand an illumination region.

As shown in FIGS. 1-7, the second light emitting region 301 is of an annular structure, and the first light emitting region 201 is located in the second light emitting region 301.

The second light emitting region 301 is of a structure of a circular ring, a rectangular ring, a polygonal ring, an elliptical ring, etc. Specifically, the structure may be adaptively set as required so long as the first light emitting region 201 may be allowed to be mounted in a region formed by an inner ring of an annular structure.

Specifically, the second light emitting region 301 of the annular structure emits annular illumination light, the first light emitting region 201 is located in the second light emitting region 301 so as to provide the scene light, and the first light emitting region 201 and the second light emitting region 301 do not overlap each other. In this way, interference between the illumination light and the scene light is reduced, the situation that an effect of scene simulation and illumination is influenced due to mutual interference between the scene light and the illumination light is avoided, and use efficiency of the lamp is improved.

In an embodiment, a first light emitting surface of the first light emitting region 201 and a second light emitting surface of the second light emitting region 301 are staggered in a height direction of the lamp body 10. Specifically, the first light emitting surface is located above the second light emitting surface. That is, a light emitting surface of the scene light is located above a light emitting surface of the illumination light. Through a height difference H between the two light emitting surfaces, a visual effect of skylight is achieved, which further highlights a visual sense of the scene light of the lamp.

In the embodiment, the first light emitting region 201 emits light with a main light emitting direction facing away from the lamp body 10 in the height direction of the lamp body 10, and the second light emitting region 301 emits light in a direction facing away from the lamp body 10 in the height direction of the lamp body 10. That is, the first light emitting region 201 and the second light emitting region 301 both emit light towards the light output port of the lamp body 10. The light output port of the lamp body 10 may emit light rays towards a ceiling, wall, etc.

In the embodiment, the lamp body 10 is in a shape of a polygon, a circle or an ellipse, or a combination of at least two of the polygon, the circle and the ellipse.

As shown in FIGS. 1-7, the first light emitting assembly 20 includes the first light source 210, a first light output assembly 220, and the image layer 222. The first light output assembly 220 is arranged on the lamp body 10 and spaced from an inner bottom surface of the lamp body 10. The first light source 210 is arranged between the first light output assembly 220 and an inner bottom surface of the lamp body 10. The image layer 222 is arranged on the first light output assembly 220 and/or the lamp body 10.

Specifically, the image layer 222 is connected to the first light output assembly 220. Alternatively, the image layer 222 is connected to the lamp body 10 and used in cooperation with the first light output assembly 220.

In an embodiment, the first light output assembly 220 is one of a light guide plate 223, a transparent plate 221 and a diffusion plate, or formed by overlapping at least two of the light guide plate 223, the transparent plate 221 and the diffusion plate.

The image layer 222 is arranged on the first light output assembly 220, and light from the first light source 210 passes through the image layer 222 so as to form the scene light before the scene light is emitted.

In an embodiment, the first light output assembly 220 at least includes the transparent plate 221. The image layer 222 is arranged on one side of the transparent plate 221 facing the first light source 210. One side of the transparent plate 221 away from the image layer 222 is formed with a first light emitting surface. A light ray of the first light source 210 is directly emitted to the image layer 222, passes through the transparent plate 221, and then is emitted out from the first light emitting surface.

Certainly, the image layer 222 is arranged on one side of the transparent plate 221, and alternatively, the image layer 222 is arranged on one side of the light guide plate 223 or the diffusion plate, which is not limited herein. One side of the light guide plate 223 or the diffusion plate away from the image layer 222 is provided with the first light emitting surface.

In the embodiment, the first light output assembly 220 at least includes the transparent plate 221, the light guide plate 223, a reflective plate 224 and foam 225 that are sequentially arranged close to an inner bottom surface of the lamp body 10.

Certainly, the first light output assembly 220 further includes other light transmitting plates. The light transmitting plates is full light transmitting plates like the transparent plate 221 and the light guide plate 223, or semi-light-transmitting plates.

In an embodiment, the transparent plate 221 and the image layer 222 are both arranged on the lamp body 10, and a spacer layer 2261 is formed between the transparent plate 221 and the image layer 222 in the height direction of the lamp body 10. A virtual visual depth of the scene light is enhanced by means of the spacer layer 2261, and further a deep visual sense is achieved during external observation.

In an embodiment, the first light emitting assembly 20 further includes a spacer plate 226. The spacer plate 226 is arranged between the transparent plate 221 and the image layer 222. The spacer plate 226 abuts against a peripheral region of the transparent plate 221 and the image layer 222, such that the spacer layer 2261 is formed between a central area of the transparent plate 221 and a central area of the image layer 222. The spacer plate 226 is arranged between the transparent plate 221 and the image layer 222. Stability of connection between the transparent plate 221 and the image layer 222 is ensured advantageously by technical means of forming the spacer layer 2261 between the transparent plate 221 and the image layer 222 by means of the spacer plate 226. A virtual visual depth of the scene light is enhanced by means of the spacer layer 2261, and further a deep visual sense is achieved during external observation.

In the embodiment, the image layer 222 is a light transmitting film having an image, and the light transmitting film is attached to an end surface of the light guide plate 223 facing the transparent plate 221. Alternatively, the image layer 222 is an ink layer printed on an end surface of the light guide plate 223 facing the transparent plate 221. Alternatively, the image layer 222 is an ink layer printed on a side surface of the transparent plate surface of the transparent plate 221 facing the light guide plate 223. Alternatively, the image layer 222 is an image plate having a pattern.

It should be noted that a type of printing is silk screen printing, pad printing, laser printing, ultraviolet (UV) printing, or any other printing methods so long as an image is formed by means of printing.

As shown in FIGS. 1-7, the second light emitting assembly 30 includes the second light source 310 and a second light output assembly 320. The second light source 310 is arranged on the lamp body 10. The second light output assembly 320 is located below the second light source 310 in the height direction of the lamp body 10. The second light source 310 emits light towards the second light output assembly 320. A side surface of the second light output assembly 320 away from the second light source 310 is a second light emitting surface.

Specifically, the second light source 310 emits the illumination light towards outside of the lamp body 10 by passing through the second light emitting surface, so as to achieve an illumination effect. The second light output assembly 320 is mounted on the lamp body 10.

In an embodiment, the second light output assembly 320 is one of the light guide plate 223, the transparent plate 221 and the diffusion plate, or formed by overlapping at least two of the light guide plate 223, the transparent plate 221 and the diffusion plate.

Certainly, the second light output assembly 320 further includes other light transmitting plates. The light transmitting plates is full light transmitting plates like the transparent plate 221, or semi-light-transmitting plates.

In the embodiment, the lamp body 10 includes a back plate 110 and an enclosing plate 120. The enclosing plate 120 is mounted on a bottom surface of the back plate 110. The enclosing plate 120 extends along a peripheral edge of the back plate 110 so as to form a mounting cavity. The first light emitting assembly 20 and the second light emitting assembly 30 are mounted in the mounting cavity. The back plate 110 is configured to be connected to a position allowing the back plate to be mounted. The position allowing the back plate to be mounted is a ceiling, a wall, a cabinet, a floor, etc.

As shown in FIGS. 1-7, the lamp further includes a baffle 40. The baffle 40 is mounted in the mounting cavity. The baffle 40 separates the mounting cavity into the first light emitting region 201 and the second light emitting region 301 that are independent of each other.

Specifically, the baffle 40 is arranged to separate the mounting cavity into the first light emitting region 201 and the second light emitting region 301, and further a technical effect of reducing mutual interference between the scene light and the illumination light is achieved by using the baffle 40.

In an embodiment, the baffle 40 is of an annular structure. An inner peripheral surface of the baffle 40 is formed with a light emitting region. The light emitting region is the first light emitting region 201 or the second light emitting region 301.

It should be noted that when a height of the enclosing plate 120 is great enough, for instance, the enclosing plate 120 has the same height as the baffle, an annular region is formed between an outer peripheral surface of the baffle 40 and an inner peripheral surface of the enclosing plate 120, and one of the light emitting region and the annular region is the first light emitting region 201 while the other region is the second light emitting region 301. The annular region is the second light emitting region 301, and the light emitting region is the first light emitting region 201.

It should be noted that when the first light emitting region 201 is located in the second light emitting region 301, the light emitting region formed by an inner peripheral surface of the baffle 40 is a circular region, an elliptical region, a rectangular region, a polygonal region, etc.

In an embodiment, the baffle 40 is provided with an upper supporting part 410 extending towards the first light emitting region 201 and a lower supporting part 420 extending towards the second light emitting region. The upper supporting part 410 is located above the lower supporting part 420 in the height direction of the lamp body 10. A top surface of the upper supporting part 410 abuts against the first light emitting surface of the first light emitting assembly 20, and a top surface of the lower supporting part 420 abuts against the second light emitting surface of the second light emitting assembly 30.

The upper supporting part 410 is configured to support the first light emitting surface, and the lower supporting part 420 is configured to support the second light emitting surface, such that an effect that the first light emitting surface and the second light emitting surface has a height difference in the height direction of the lamp body 10 is achieved.

In an embodiment, the upper supporting part 410 is arranged in parallel with the first light emitting surface, such that surface-to-surface contact is achieved, and damage to the first light emitting surface is avoided while mounting stability is improved.

In an embodiment, the lower supporting part 420 is arranged in parallel with the second light emitting surface, such that surface-to-surface contact is achieved, and damage to the second light emitting surface is avoided while mounting stability is improved.

In the embodiment, the first light source 210 is mounted on the inner bottom surface of the back plate 110, so as to directly emit light towards the light output port at the bottom of the lamp body 10.

In the embodiment, the lamp further includes a controller and a control switch 50. The controller is in signal connection with the first light emitting assembly 20 and/or the second light emitting assembly 30. The control switch 50 is in signal connection with the controller. The controller and the control switch 50 are arranged on the lamp body 10 or separated from the lamp body 10. The control switch 50 at least includes one of a color temperature adjustment switch 510, a scene light adjustment switch 520, and a power adjustment switch 530.

In the embodiment, the color temperature adjustment switch 510 is configured to adjust color temperatures of the first light source 210 and the second light source 310, so as to satisfy demand of different people for light. The power adjustment switch 530 is configured to adjust power of the first light source 210 and the second light source 310, and adjust an illumination intensity through power adjustment, so as to satisfy demand of different people for light. The scene light adjustment switch 520 is configured to adjust a color of the first light source 210, that is, adjust a light color of the first light source 210, so as to adjust the scene light emitted from the first light source 210 and passing through the image layer 222. For instance, a scene of blue sky and white clouds at noon is switched to a scene of sky and clouds at dusk by means of the scene light adjustment switch 520.

### Embodiment 2

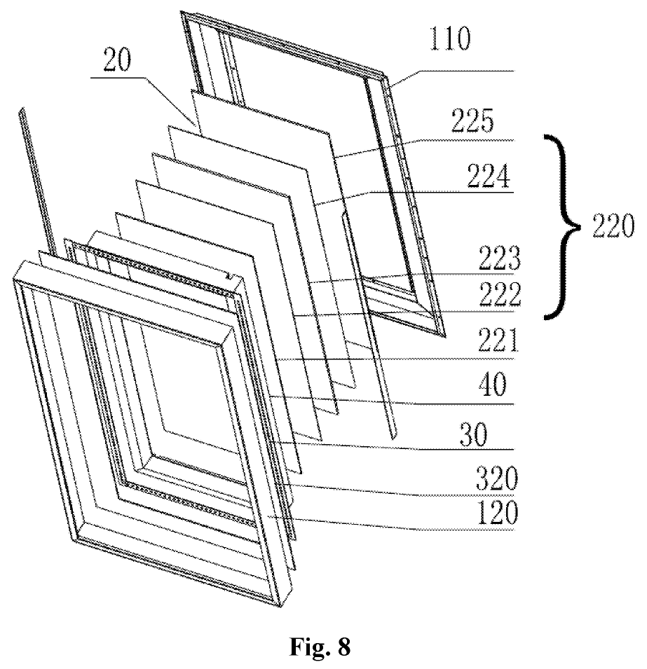

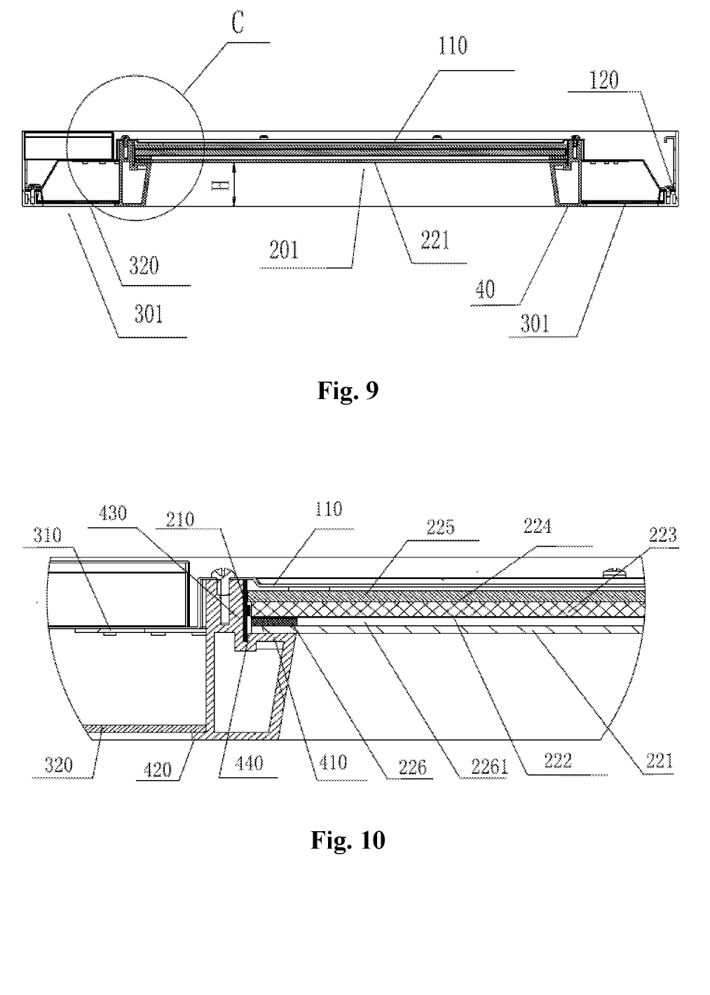

In the embodiment, as shown in FIGS. 8-10, a first light emitting region 201 is arranged in a second light emitting region 301, and the first light emitting region 201 and the second light emitting region 301 both emit light with main light emitting directions facing the same side of the lamp body 10. The embodiment is different from embodiment 1 in that the first light source 210 is arranged at an outer lateral of the first light output assembly 220.

Specifically, the first light output assembly 220 at least includes a transparent plate 221. An image layer 222 is arranged between an inner bottom surface of the lamp body 10 and the transparent plate 221. One side of the transparent plate 221 away from the image layer 222 is formed with a first light emitting surface.

In the embodiment, the first light output assembly 220 at least includes the transparent plate 221, a light guide plate 223 and a reflective plate 224 that are sequentially arranged close to the inner bottom surface of the lamp body 10.

In an embodiment, the transparent plate 221 and the image layer 222 are both arranged on the lamp body 10, and a spacer layer 2261 is formed between the transparent plate 221 and the image layer 222 in the height direction of the lamp body 10. A virtual visual depth of scene light is enhanced by means of the spacer layer 2261, and further a deep visual sense is achieved during external observation.

In an embodiment, a first light emitting assembly 20 further includes a spacer plate 226. The spacer plate 226 is arranged between the transparent plate 221 and the image layer 222. The spacer plate 226 abuts against a peripheral region of the transparent plate 221 and the image layer 222, such that the spacer layer 2261 is formed between a central area of the transparent plate 221 and a central area of the image layer 222. The spacer plate 226 is arranged between the transparent plate 221 and the image layer 222. Stability of connection between the transparent plate 221 and the image layer 222 is ensured advantageously by technical means of forming the spacer layer 2261 between the transparent plate 221 and the image layer 222 by means of the spacer plate 226. A virtual visual depth of the scene light is enhanced by means of the spacer layer 2261, and further a deep visual sense is achieved during external observation.

In the embodiment, the image layer 222 is a light transmitting film having an image, and the light transmitting film is attached to an end surface of the light guide plate 223 facing the transparent plate 221. Alternatively, the image layer 222 is an ink layer printed on an end surface of the light guide plate 223 facing the transparent plate 221. Alternatively, the image layer 222 is an ink layer printed on a side surface of the transparent plate surface of the transparent plate 221 facing the light guide plate 223. Alternatively, the image layer 222 is an image plate having a pattern.

It should be noted that a type of printing is silk screen printing, pad printing, laser printing, UV printing, or any other printing methods so long as an image is formed by means of printing.

As shown in FIGS. 8-10, the first light emitting assembly 20 at least includes the first light source 210. A baffle 40 is provided with a mounting part 430. The mounting part 430 is connected to an upper supporting part 410 in a bent manner. A mounting groove 440 is formed at a joint of the mounting part 430 and the upper supporting part 410. The first light source 210 is attached to an end surface of the mounting part 430 facing the first light emitting region 201 and at least partially located in the mounting groove 440.

The first light source 210 is at least partially mounted in the mounting groove 440, so as to achieve an effect of clamping and positioning. The first light source 210 is attached to the end surface of the mounting part 430 facing the first light emitting region 201, so as to achieve a technical effect of side light emission of the first light source 210.

In an embodiment, the first light source 210 and the end surface of the mounting part 430 is connected to each other through bonding, fastening by fasteners, etc.

In an embodiment, the mounting part 430 is arranged perpendicular to the upper supporting part 410.

It should be noted that in the embodiment, light from the first light source 210 is emitted towards the first light emitting region 201 and emitted out from the first light emitting surface, and the first light emitting surface and the second light emitting surface are arranged in the same direction, such that the main light emitting directions of the first light emitting region 201 and the second light emitting region 301 are set in the same direction.

### Embodiment 3

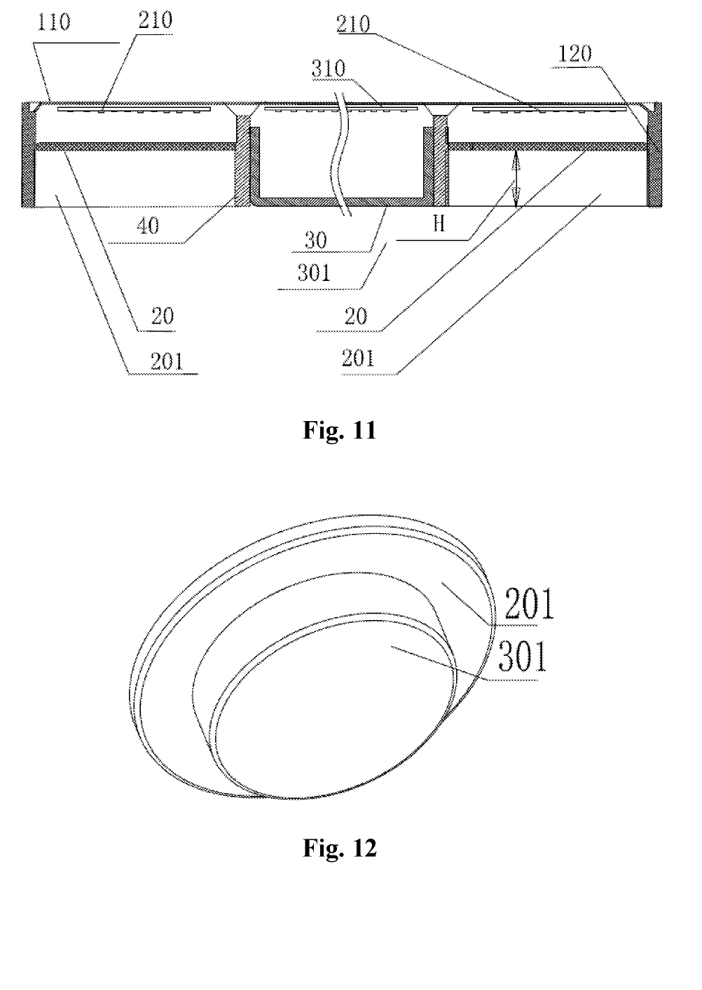

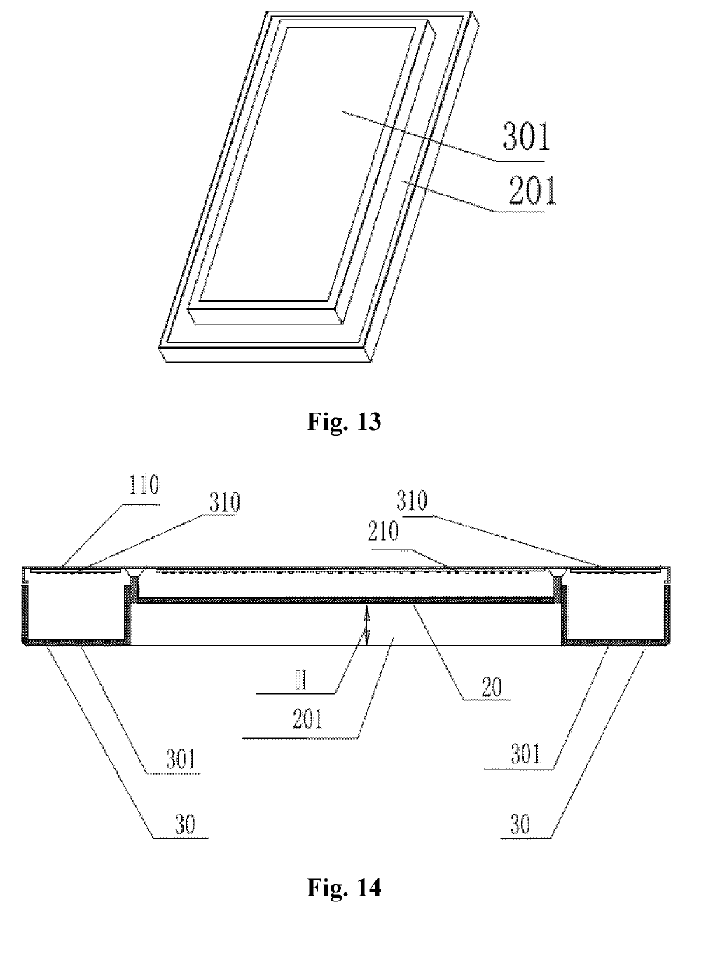

The embodiment is different from embodiment 1 in that a first light emitting region 201 is of an annular structure, and a second light emitting region 301 is located in the first light emitting region 201, as shown in FIGS. 11-14.

The first light emitting region 201 is of a structure of a circular ring, a rectangular ring, a polygonal ring, an elliptical ring, etc. Specifically, the structure may be adaptively set as required so long as the second light emitting region 301 may be allowed to be mounted in a region formed by an inner ring of an annular structure.

Specifically, the first light emitting region 201 of the annular structure emits annular illumination light, the second light emitting region 301 is located in the first light emitting region 201 so as to provide the illumination light, and the first light emitting region 201 and the second light emitting region 301 do not overlap each other. In this way, interference between the illumination light and the scene light is reduced, the situation that an effect of scene simulation and illumination is influenced due to mutual interference between the scene light and the illumination light is avoided, and use efficiency of the lamp is improved.

In the embodiment, a second light source 310 is arranged at an outer lateral of a second light output assembly 320, and a side surface of the second light output assembly 320 away from a lamp body 10 is a second light emitting surface.

The second light source 310 emits light towards a lateral. The second light source 310 is attached to an end surface of a baffle 40 facing the second light emitting region 301. The second light source 310 and the baffle 40 are fixedly connected to each other through bonding, fastening by fasteners, etc.

It should be noted that in order to enhance mounting stability of the second light source 310, a groove structure is provided on the baffle such that at least part of the second light source 310 is mounted in the groove structure, and further an effect of fixing the second light source 310 is achieved.

In an embodiment, a first light emitting surface of the first light emitting region 201 and a second light emitting surface of the second light emitting region 301 are staggered in a height direction of the lamp body 10. Specifically, the first light emitting surface is located above the second light emitting surface. That is, a light emitting surface of the scene light is located above a light emitting surface of the illumination light. Through a height difference H between the two light emitting surfaces, the scene light is achieved, and a visual effect of skylight is achieved, which further highlights a visual impression of the scene light of the lamp.

In an embodiment, the baffle 40 is of an annular structure. An inner peripheral surface of the baffle 40 is formed with a light emitting region. The light emitting region is the first light emitting region 201 or the second light emitting region 301.

It should be noted that when a height of an enclosing plate 120 is great enough, for instance, the enclosing plate 120 has the same height as the baffle, an annular region is formed between an outer peripheral surface of the baffle 40 and an inner peripheral surface of the enclosing plate 120, and one of the light emitting region and the annular region is the first light emitting region 201 while the other region is the second light emitting region 301. The annular region is the first light emitting region 201, and the light emitting region is the second light emitting region 301.

It should be noted that when the first light emitting region 201 is located in the second light emitting region 301, the light emitting region formed by an inner peripheral surface of the baffle 40 is a circular region, an elliptical region, a rectangular region, a polygonal region, etc.

### Embodiment 4

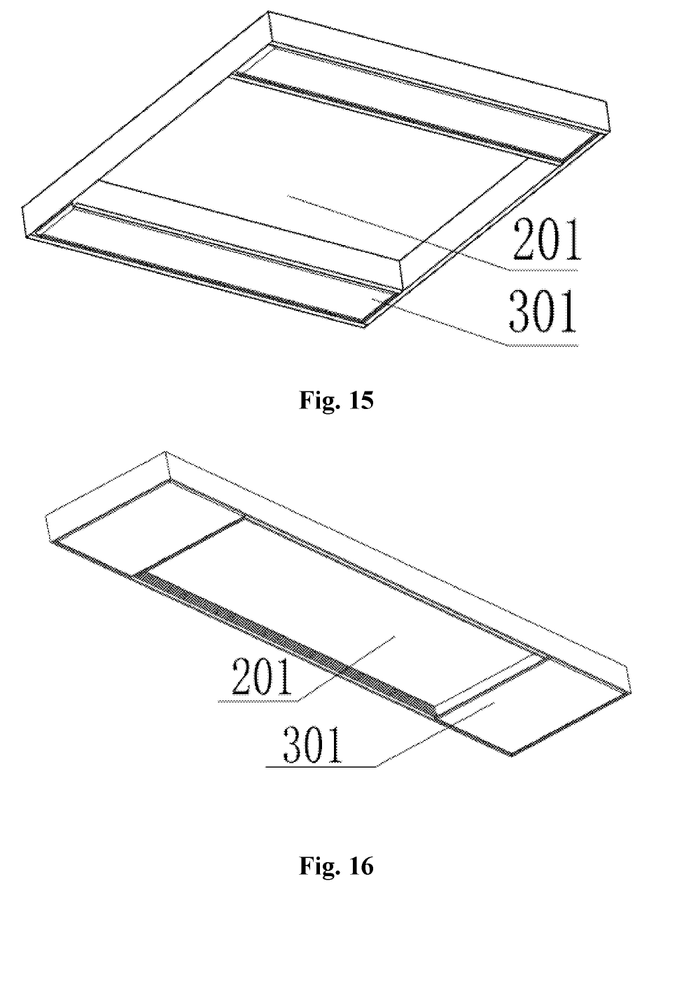

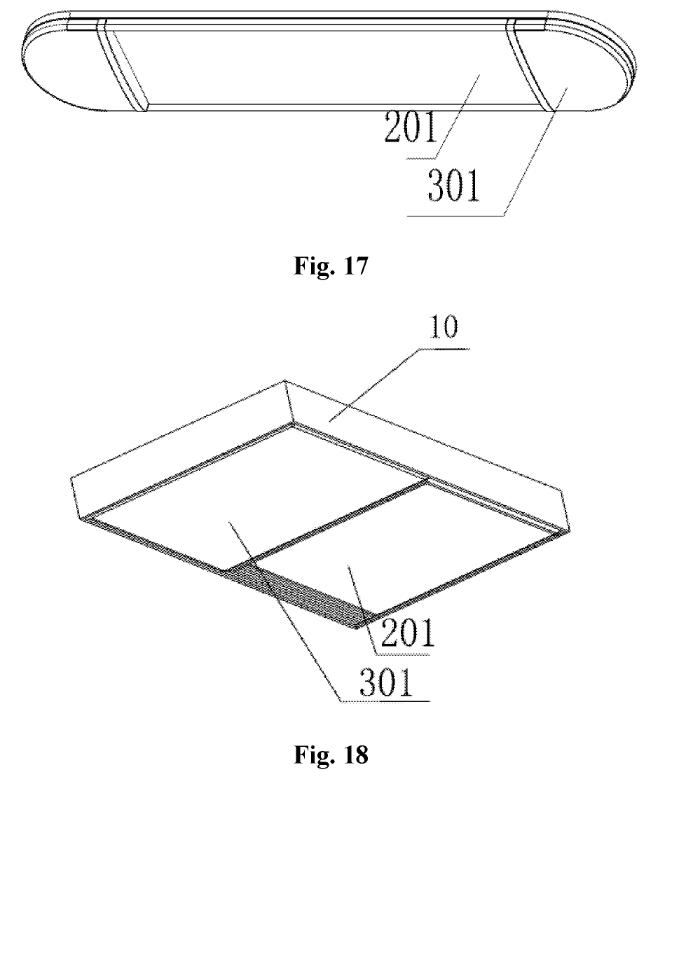

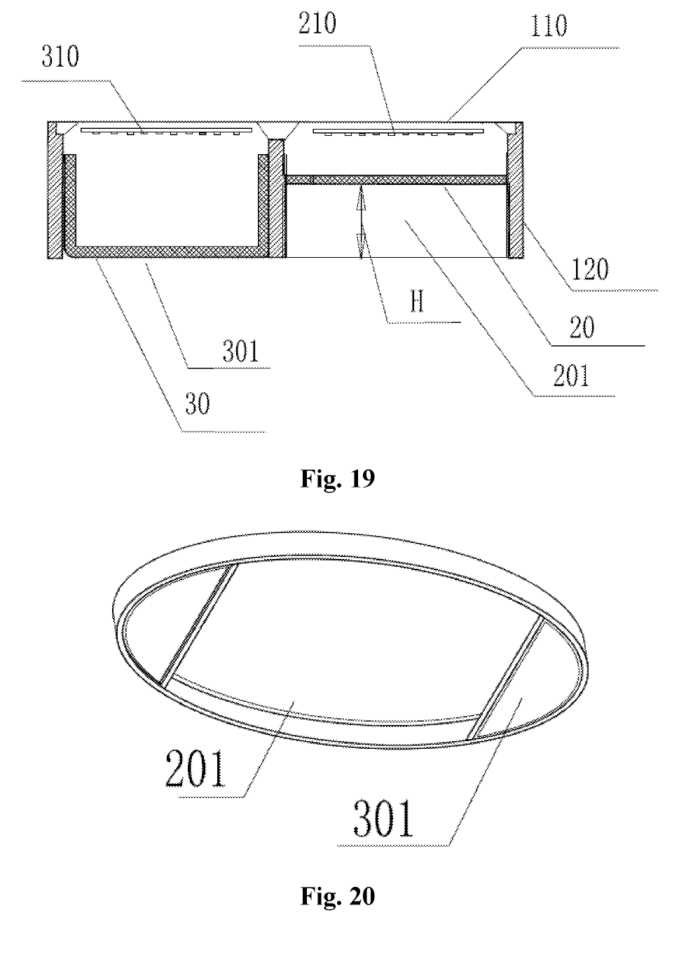

The embodiment is different from embodiment 1 in that a first light emitting region 201 and a second light emitting region 301 are alternately arranged in a length direction of a lamp body 10, as shown in FIGS. 15-19.

The number of the first light emitting regions 201 and the second light emitting regions 301 that are alternately arranged may be set as required.

Specifically, the lamp body 10 is of a long strip structure. That is, an enclosing plate 120 encloses a long strip region, and a baffle 40 is arranged in the long strip region so as to separate the long strip region into the first light emitting regions 201 and the second light emitting regions 301 that are alternately arranged.

In an embodiment, the baffle 40 is of a straight plate structure.

In a specific embodiment of the disclosure, when one first light emitting region 201 and one second light emitting region 301 are arranged, the baffle 40 is arranged between the enclosing plates 120 at two ends of the lamp body 10 in the length direction of the lamp body 10, so as to separate a mounting cavity into two parallel regions independently configured in the length direction of the lamp body 10, one of the two parallel regions is the first light emitting region 201, and the other parallel region is the second light emitting region 301.

In another specific embodiment of the disclosure, when a plurality of first light emitting regions 201 and/or a plurality of second light emitting regions 301 are arranged, a plurality of baffles 40 are arranged between the enclosing plates 120 at two ends of the lamp body 10 accordingly. In an embodiment, a plurality of parallel regions are separated by means of the baffles 40, so as to correspond to the first light emitting regions 201 and the second light emitting regions 301.

It should be noted that when the enclosing plates 120 at two ends of the long strip region are arc-shaped plates, light emitting regions at the two ends are corresponding arc-shaped regions.

### Embodiment 5

The embodiment is different from embodiment 4 in that as shown in FIG. 20, an enclosing plate 120 of the lamp body 10 encloses a circular region, and a baffle 40 is arranged in the circular region, so as to separate the circular region into at least one first light emitting region 201 and at least one second light emitting region 301.

When one baffle 40 is arranged, one first light emitting region and one second light emitting region 301 are arranged and are both semicircular regions. When a plurality of baffles 40 are arranged, the plurality of baffles 40 are arranged in the circular region in parallel so as to separate a region in the circular region into a plurality of first light emitting regions 201 or a plurality of second light emitting regions 301.

### Embodiment 6

The embodiment is different from embodiment 1 in that a first light emitting region 201 is arranged in a second light emitting region 301, and the second light emitting region 301 emits light towards a lateral of a lamp body 10 in a direction perpendicular to a height of the lamp body 10.

Specifically, a main light emitting direction of the first light emitting region 201 is set different from a main light emitting direction of the second light emitting region 301.

In a height direction of the lamp body 10, the first light emitting region 201 emits light in a direction facing away from the lamp body 10, and the first light emitting region 201 directly emits scene light towards a light output port at a bottom of the lamp body 10. The second light emitting region 301 emits light towards an outer peripheral side of the lamp body 10 so as to provide circumferential illumination light.

### Embodiment 7

The embodiment is different from embodiment 1 in that a second light emitting region 301 is arranged in a first light emitting region 201, and the first light emitting region 201 emits light towards a lateral of a lamp body 10 in a direction perpendicular to a height of the lamp body 10.

Specifically, a main light emitting direction of the first light emitting region 201 is set different from a main light emitting direction of the second light emitting region 301.

In a height direction of the lamp body 10, the second light emitting region 301 emits light in a direction facing away from the lamp body 10, and the second light emitting region 301 directly emits illumination light towards a light output port at a bottom of the lamp body 10. The first light emitting region 201 emits light towards an outer peripheral side of the lamp body 10 so as to provide circumferential scene light.

From the above description, it may be seen that the above embodiments of the disclosure achieve the following technical effects:

The lamp body 10 of the lamp of the disclosure is provided with the first light emitting assembly 20 and the second light emitting assembly 30 that emit light independently, where the first light emitting region 201 emits the scene light to simulate environments, such as blue sky and white clouds, and the second light emitting region 301 generates the illumination light for illumination. The lamp of the disclosure may not only achieve illumination, but also achieve a technical effect of creating a scene by means of the scene light. By means of the lamp, people may feel like in a comfortable, healthy and natural light environment, and may have a pleasant mood. According to the disclosure, the first light emitting assembly 20 and the second light emitting assembly 30 generate various light rays at the same time, such that a technical problem of single light rays in the related art is solved, and use experience is improved.

Obviously, the embodiments described above are merely some embodiments rather than all embodiments of the disclosure. Based on the embodiments of the disclosure, all other embodiments obtained by those of ordinary skill in the art without making creative efforts should fall within the scope of protection of the disclosure.

It should be noted that the terms used herein are merely for describing the detailed description of embodiments and are not intended to limit illustrative embodiments according to the disclosure. As used herein, the singular is also intended to include the plural unless the context clearly points out the singular or plural. In addition, it should be understood that terms “include” and/or “comprise” used in the description indicate the presence of features, steps, operations, devices, assemblies, and/or their combinations.

It should be noted that the terms “first”, “second”, etc., in the description and claims of the disclosure and in the drawings, are used to distinguish between similar objects and not necessarily to describe a particular order or sequential order. It should be understood that data used in this way may be interchanged where appropriate, such that the embodiments of the disclosure described herein may be implemented in other orders than those illustrated or described herein.

What are described above are merely the preferred embodiments of the disclosure and are not intended to limit the disclosure, and various changes and modifications may be made by those skilled in the art. Any modifications, equivalent substitutions, improvements, etc. made within the spirit and principle of the disclosure should fall within the scope of protection of the disclosure.

1. A lamp, comprising:
a lamp body;
a first light emitting assembly, wherein the first light emitting assembly has a first light emitting region, the first light emitting assembly at least comprises an image layer arranged in the first light emitting region, and light from the first light emitting region passes through the image layer before scene light is emitted; and
a second light emitting assembly, wherein the first light emitting assembly and the second light emitting assembly are independently arranged on the lamp body, and the second light emitting assembly has a second light emitting region configured to emit illumination light.

2. The lamp according to claim 1, wherein
the first light emitting region and the second light emitting region emit light with main light emitting directions facing the same side of the lamp body; or
main light emitting directions of the first light emitting region and the second light emitting region are formed with an angle therebetween; or
the first light emitting region is of an annular structure, and the second light emitting region is located in the first light emitting region; or
the second light emitting region is of an annular structure, and the first light emitting region is located in the second light emitting region; or
the first light emitting region and the second light emitting region are alternately arranged in a length direction of the lamp body.

3. The lamp according to claim 1, wherein a first light emitting surface of the first light emitting region and a second light emitting surface of the second light emitting region are staggered in a height direction of the lamp body.

4. The lamp according to claim 3, wherein the first light emitting surface is located above the second light emitting surface.

5. The lamp according to claim 1, wherein
in a height direction of the lamp body, the first light emitting region emits light with a main light emitting direction facing away from the lamp body; and/or
in a direction perpendicular to a height of the lamp body, the first light emitting region emits light towards a lateral of the lamp body; and/or
in a height direction of the lamp body, the first light emitting region emits light towards the lamp body.

6. The lamp according to claim 1, wherein
in a height direction of the lamp body, the second light emitting region emits light in a direction facing away from the lamp body; and/or
in a direction perpendicular to a height of the lamp body, the second light emitting region emits light towards a lateral of the lamp body; and/or
in a height direction of the lamp body, the second light emitting region emits light towards the lamp body.

7. The lamp according to claim 1, wherein the lamp body is in a shape of a polygon, a circle or an ellipse, or a combination of at least two of the polygon, the circle and the ellipse.

8. The lamp according to claim 1, wherein the first light emitting assembly comprises:
a first light source;
a first light output assembly, wherein the first light output assembly is arranged on the lamp body and spaced from an inner bottom surface of the lamp body, the first light source is arranged at an outer lateral of the first light output assembly, and/or the first light source is arranged between the first light output assembly and an inner bottom surface of the lamp body; and
the image layer, wherein the image layer is arranged on the first light output assembly and/or the lamp body.

9. The lamp according to claim 8, wherein
when the first light source is arranged at the outer lateral of the first light output assembly, the first light output assembly at least comprises a transparent plate, the image layer is arranged between the inner bottom surface of the lamp body and the transparent plate, and one side of the transparent plate away from the image layer is formed with a first light emitting surface; and
when the first light source is arranged between the first light output assembly and the inner bottom surface of the lamp body, the first light output assembly at least comprises a transparent plate, the image layer is arranged on one side of the transparent plate facing the first light source, and one side of the transparent plate away from the image layer is formed with a first light emitting surface.

10. The lamp according to claim 9, wherein the first light output assembly further comprises a light guide plate arranged between the transparent plate and the inner bottom surface of the lamp body,
the image layer is a light transmitting film having an image, and the light transmitting film is attached to the first light output assembly; or
the image layer is an ink layer printed on the first light output assembly; or
the image layer is an image plate having a pattern.

11. The lamp according to claim 9, wherein the first light emitting assembly further comprises:
a spacer layer, wherein the spacer layer is directly formed between the transparent plate and the image layer; or,
a spacer plate, wherein the spacer plate is arranged between the transparent plate and the image layer, and the spacer plate abuts against a peripheral region of the transparent plate and the image layer, such that a spacer layer is formed between a central area of the transparent plate and a central area of the image layer.

12. The lamp according to claim 1, wherein the second light emitting assembly comprises:
a second light source, wherein the second light source is arranged on the lamp body; and
a second light output assembly, wherein the second light output assembly is arranged on the lamp body and spaced from an inner bottom surface of the lamp body, the second light source is arranged at an outer lateral of the second light output assembly, and/or the second light source is arranged between the second light output assembly and an inner bottom surface of the lamp body, and a side surface of the second light output assembly away from the lamp body is a second light emitting surface.

13. The lamp according to claim 1, wherein the lamp body comprises:
a back plate; and
an enclosing plate, wherein the enclosing plate is mounted on a bottom surface of the back plate, the enclosing plate extends along a peripheral edge of the back plate so as to form a mounting cavity, and the first light emitting assembly and the second light emitting assembly are mounted in the mounting cavity.

14. The lamp according to claim 13, wherein the lamp further comprises a baffle, wherein the baffle is mounted in the mounting cavity, and the baffle separates the mounting cavity into the first light emitting region and the second light emitting region that are independent of each other.

15. The lamp according to claim 14, wherein the baffle is of an annular structure, an inner peripheral surface of the baffle is formed with a light emitting region, and the light emitting region is the first light emitting region or the second light emitting region.

16. The lamp according to claim 14, wherein in a length direction of the lamp body, the baffle is arranged between enclosing plates at two ends of the lamp body so as to separate the mounting cavity into two parallel regions independently configured in the length direction of the lamp body, one of the two parallel regions is the first light emitting region, and the other parallel region is the second light emitting region.

17. The lamp according to claim 14, wherein the baffle is provided with an upper supporting part extending towards the first light emitting region and a lower supporting part extending towards the second light emitting region, the upper supporting part is located above the lower supporting part in a height direction of the lamp body, a top surface of the upper supporting part abuts against the first light emitting surface of the first light emitting assembly, and a top surface of the lower supporting part abuts against the second light emitting surface of the second light emitting assembly.

18. The lamp according to claim 17, wherein
the upper supporting part is arranged in parallel with the first light emitting surface; and/or
the lower supporting part is arranged in parallel with the second light emitting surface.

19. The lamp according to claim 17, wherein the first light emitting assembly at least comprises the first light source, the baffle is provided with a mounting part, the mounting part is connected to the upper supporting part in a bent manner, a mounting groove is formed at a joint of the mounting part and the upper supporting part, and
the first light source is mounted on an inner bottom surface of the back plate; and/or
the first light source is attached to an end surface of the mounting part facing the first light emitting region and at least partially located in the mounting groove.

20. The lamp according to claim 1, wherein the lamp further comprises:
a controller, wherein the controller is in signal connection with the first light emitting assembly and/or the second light emitting assembly; and
a control switch, wherein the control switch is in signal connection with the controller, the controller and the control switch are arranged on the lamp body or separated from the lamp body, and the control switch at least comprises one of a color temperature adjustment switch, a scene light adjustment switch, and a power adjustment switch; and/or
the lamp is one of a pendant lamp, a ceiling lamp, a table lamp, and a floor lamp.
